(19) United States
(12) Patent Application Publication
(10) Pub. No.: US 2026/0011472 A1
(43) Pub. Date: Jan. 8, 2026

(54) COUPLING SURGE ARRESTER

(71) Applicant: CHARDON TAIWAN CORPORATION, Miaoli County (TW)

(72) Inventor: Po-Hung LU, Miaoli County (TW)

(21) Appl. No.: 18/821,471

(22) Filed: Aug. 30, 2024

(30) Foreign Application Priority Data
Jul. 8, 2024 (TW) 113125524

(51) Int. Cl. H01C 7/12

(52) U.S. Cl. CPC H01C 7/12

(57) ABSTRACT

A coupling surge arrester has a body. The body includes an arrester module and a trip unit at the front end of the arrester module. The trip unit includes a first conductor, a second conductor slidable relative to the first conductor, and at least one conductive member. A closed chamber is enclosed between the first conductor and the second conductor. The conductive member is disposed in the closed chamber. When the arrester module malfunctions, the continuously passing current will cause the temperature of the conductive member to rise sharply, and the air inside the closed chamber will expand rapidly after being heated, such that the second conductor is pushed to slide relative to the first conductor to occur a circuit break, thereby preventing the arrester module from exploding and cracking.

### FIELD OF THE INVENTION

The present invention relates to a surge arrester, and more particularly, to a coupling surge arrester for a power transmission system.

### BACKGROUND OF THE INVENTION

Conventional power transmission systems are usually equipped with multiple surge arresters. The surge arresters are grounded through a ground wire and utilize their non-linear resistive characteristics to protect the equipment of the power transmission system from damage by means of redirecting the overvoltage to the ground through the surge arresters when the power transmission system encounters surges caused by lightning strikes.

However, when the surge arresters malfunction due to factors such as long-term use, aging, moisture, etc., the high current passing through the surge arresters will cause the surge arresters to crack and explode, and the cracked parts may damage surrounding equipment and personnel. This is very dangerous.

### SUMMARY OF THE INVENTION

The primary object of the present invention is to provide a coupling surge arrester that is able to break the circuit when an arrester module malfunctions so that the current no longer flows to the ground through the arrester module. The coupling surge arrester has high safety.

In order to achieve the foregoing object, the coupling surge arrester provided by the present invention comprises body. The body has at least one coupling head for connecting an external connector and an accommodating portion for accommodating an arrester module. The body further has a communicating portion between the coupling head and the accommodating portion. A trip unit is provided in the communicating portion. The trip unit includes a first conductor, a second conductor, at least one conductive member, and at least one insulating member. The first conductor is disposed close to the coupling head. One end of the first conductor has a first connecting portion. The first connecting portion is electrically connected to the external connector. Another end of the first conductor has a first contact surface. The second conductor is disposed close to the accommodating portion. The second conductor is slidable relative to the first conductor. One end of the second conductor has a second connecting portion. The second connecting portion is electrically connected to the arrester module. Another end of the second conductor has a second contact surface. A closed chamber is enclosed between the first contact surface and the second contact surface. The conductive member is disposed in the closed chamber. Two ends of the conductive member are in contact with the first contact surface and the second contact surface, respectively, so that the first conductor and the second conductor are electrically connected through the conductive member. The insulating member is disposed between the first conductor and the second conductor so that the first conductor and the second conductor do not come into contact with each other.

When the arrester module malfunctions due to aging, the continuously passing current will cause the temperature of the conductive member to rise sharply, and the air inside the closed chamber will expand rapidly after being heated, such that the second conductor is pushed to slide relative to the first conductor, and the second contact surface is gradually moved away from the first contact surface. A circuit break occurs when the distance between the first contact surface and the second contact surface exceeds the length of the conductive member, so that the current no longer flows to the ground through the arrester module. This can prevent the arrester module from exploding and cracking due to continuous high current flow, thereby enhancing the safety of the coupling surge arrester.

### BRIEF DESCRIPTION OF THE DRAWINGS

FIG. 1 is a cross-sectional view according to a first embodiment of the present invention;

FIG. 2 is a partial, enlarged cross-sectional view according to the first embodiment of the present invention;

FIG. 3 is an exploded view of the trip unit according to the first embodiment of the present invention;

FIG. 4 is a schematic view showing the operation of the first embodiment of the present invention;

FIG. 5 is a cross-sectional view according to a second embodiment of the present invention;

FIG. 6 is a partial, enlarged cross-sectional view according to the second embodiment of the present invention; and

FIG. 7 is a schematic view showing the operation of the second embodiment of the present invention.

### DETAILED DESCRIPTION OF THE PREFERRED EMBODIMENTS

Embodiments of the present invention will now be described, by way of example only, with reference to the accompanying drawings.

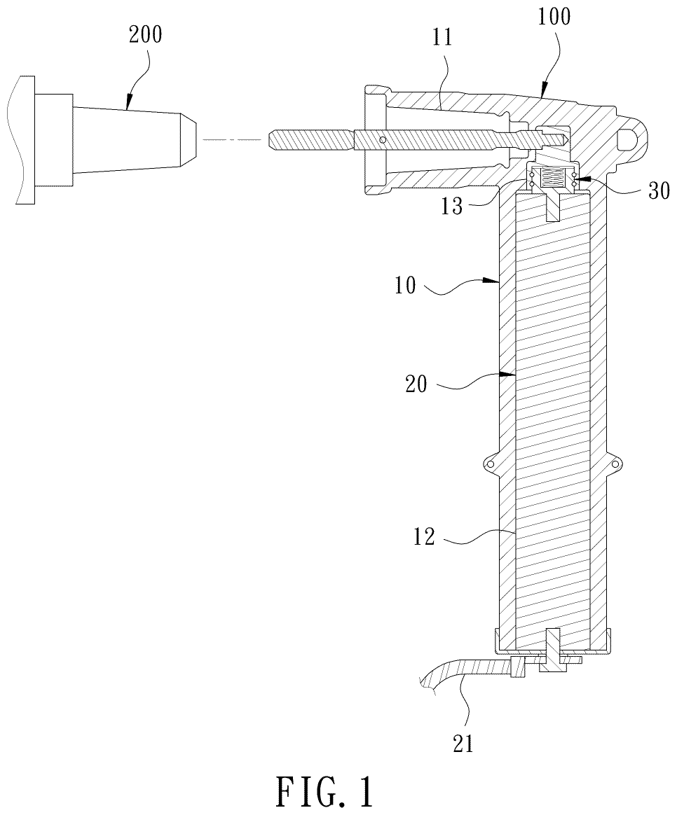

FIG. 1 is a cross-sectional view according to a first embodiment of the present invention. The present invention discloses a coupling surge arrester 100. The coupling surge arrester 100 comprises a body 10, an arrester module 20, and a trip unit 30. The body 10 may be made of rubber. The body 10 has at least one coupling head 11. The coupling head 11 is configured for connecting an external connector 200 of a power transmission system. Depending on the type of the coupling surge arrester 100, the coupling head 11 may be a plug (male interface) or a socket (female interface) as shown in this embodiment. The body 10 further has an accommodating portion 12. In this embodiment, the accommodating portion 12 is an accommodating groove for accommodating the arrester module 20. The arrester module 20 is a metal oxide arrester, such as a zinc oxide arrester. The arrester module 20 is grounded through a ground wire 21. The body 10 further has a communicating portion 13 between the coupling head 11 and the accommodating portion 12. In this embodiment, the communicating portion 13 is a communicating hole communicating with the socket and the accommodating groove. The trip unit 30 is located in the communicating hole. When the power transmission system encounters a lightning strike to generate a surge, the voltage of the power transmission system will be higher than the threshold voltage. At this time, the arrester module 20 is actuated to redirect the overvoltage to the ground through the trip unit 30 and the arrester module 20, thereby protecting the equipment of the power transmission system from damage caused by the surge.

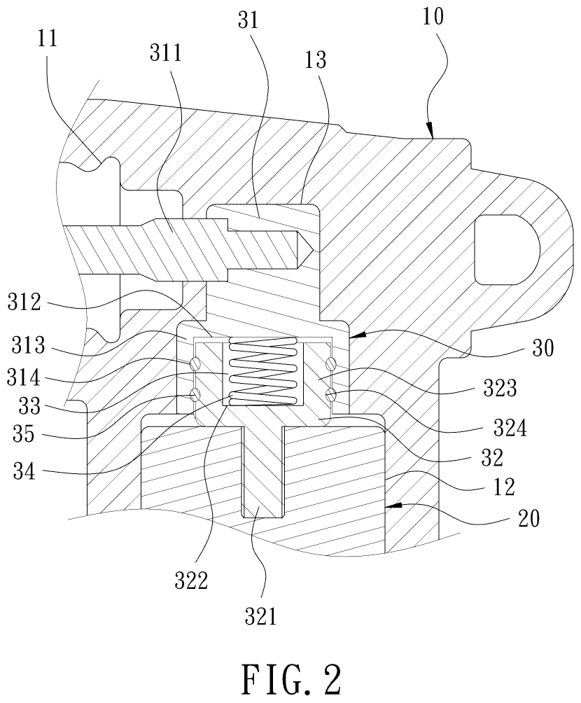

FIG. 2 is a partial, enlarged cross-sectional view according to the first embodiment of the present invention. The trip unit 30 includes a first conductor 31 disposed close to the coupling head 11 and a second conductor 32 disposed close to the accommodating portion 12. The first conductor 31 and the second conductor 32 are made of metal, such as copper or aluminum. One end of the first conductor 31 has a first connecting portion 311. The first connecting portion 311 is electrically connected to the external connector 200 shown in FIG. 1. One end of the second conductor 32 has a second connecting portion 321. The second connecting portion 321 is electrically connected to the arrester module 20. The first connecting portion 311 and the second connecting portion 321 may be in different forms depending on the type of the coupling surge arrester 100. For example, in this embodiment, the first connecting portion 311 is a pin terminal corresponding to the socket (female interface), and the second connecting portion 321 is a threaded post screwed to the arrester module 20. The other end of the first conductor 31 has a first contact surface 312, and the other end of the second conductor 32 has a corresponding second contact surface 322. A closed chamber 33 is enclosed between the first contact surface 312 and the second contact surface 322. At least one conductive member 34 is provided in the closed chamber 33. Two ends of the conductive member 34 are in contact with the first contact surface 312 and the second contact surface 322, respectively, so that the first conductor 31 and the second conductor 32 are electrically connected through the conductive member 34. The conductive member 34 may be a wire made of metal, such as a fuse having a small cross-sectional area. Preferably, the conductive member 34 is a metal spring as shown in this embodiment, such that the two ends of the conductive member 34 are elastically pressed against the first contact surface 312 and the second contact surface 322 respectively, so as to avoid poor contact effectively.

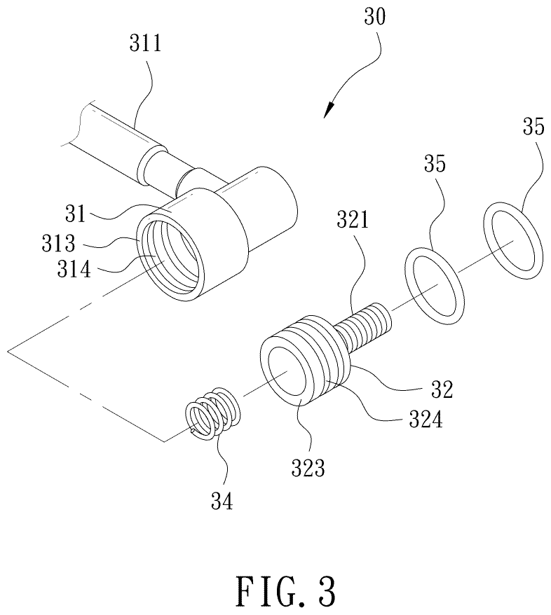

FIG. 3 is an exploded view of the trip unit according to the first embodiment of the present invention. Referring to FIG. 2, the second conductor 32 is slidable relative to the first conductor 31. At least one insulating member 35 is provided between the first conductor 31 and the second conductor 32 so that the first conductor 31 and the second conductor 32 do not come into contact with each other. In this embodiment, the first conductor 31 is fixed to the body 10. The first conductor 31 has a first annular wall 313 surrounding the first contact surface 312. The second conductor 32 has a second annular wall 323 surrounding the second contact surface 322. The outer diameter of the second annular wall 323 is less than the inner diameter of the first annular wall 313, so that the second annular wall 323 is slidably accommodated within the inner annular side of the first annular wall 313. A plurality of insulating members 35 are disposed between the first annular wall 313 and the second annular wall 323 so that the first conductor 31 and the second conductor 32 do not come into contact with each other. Preferably, the inner annular surface of the first annular wall 313 has a first annular groove 314 corresponding to each insulating member 35, and the outer annular surface of the second annular wall 323 has a corresponding second annular groove 324. The insulating members 35 are rings made of an insulating material, such has plastic, rubber and the like, and are received in the corresponding first and second annular grooves 314, 324 in pairs, respectively.

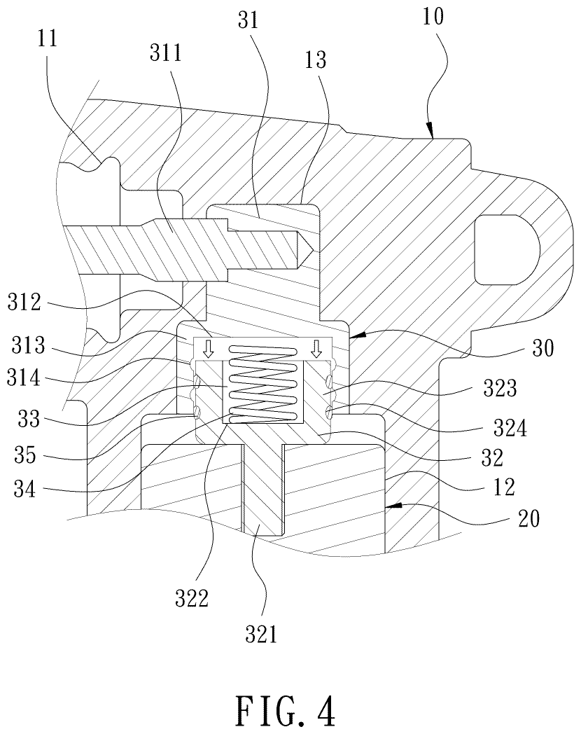

FIG. 4 is a schematic view showing the operation of the first embodiment of the present invention. The first conductor 31 and the second conductor 32 are not in contact with each other, but are in electrical connection with each other through the conductive member 34. Therefore, the current passing through the trip unit 30 will only flow from the first conductor 31 through the conductive member 34 to the second conductor 32, and then be redirected to the ground through the arrester module 20. When the arrester module 20 malfunctions due to aging, humidity, or other factors, the continuously passing current will cause the temperature of the conductive member 34 to rise sharply, and the air inside the closed chamber 33 will expand rapidly after being heated, such that the second conductor 32 and the arrester module 20 are pushed to slide relative to the first conductor 31, and the second contact surface 322 is gradually moved away from the first contact surface 312. A circuit break occurs when the distance between the first contact surface 312 and the second contact surface 322 exceeds the length of the conductive member 34, so that the current no longer flows to the ground through the arrester module 20. This can prevent the arrester module 20 from exploding and cracking due to continuous high current flow, thereby enhancing the safety of the coupling surge arrester 100.

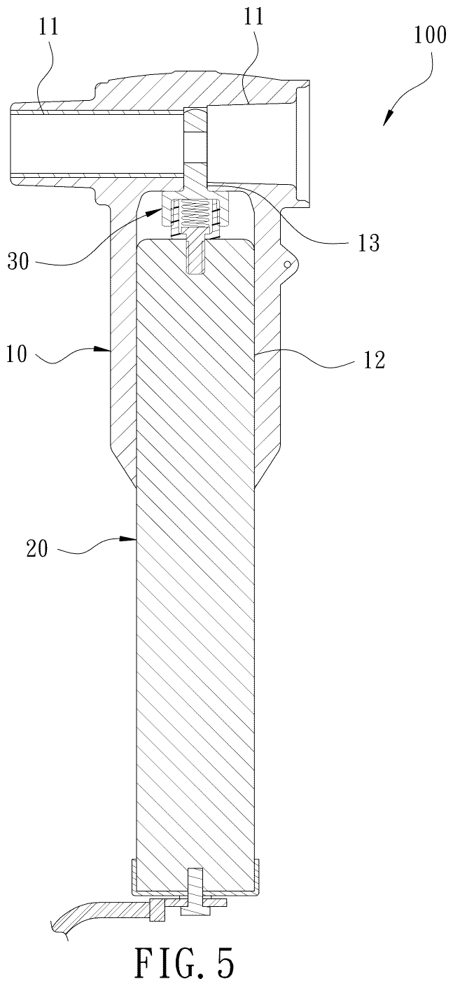

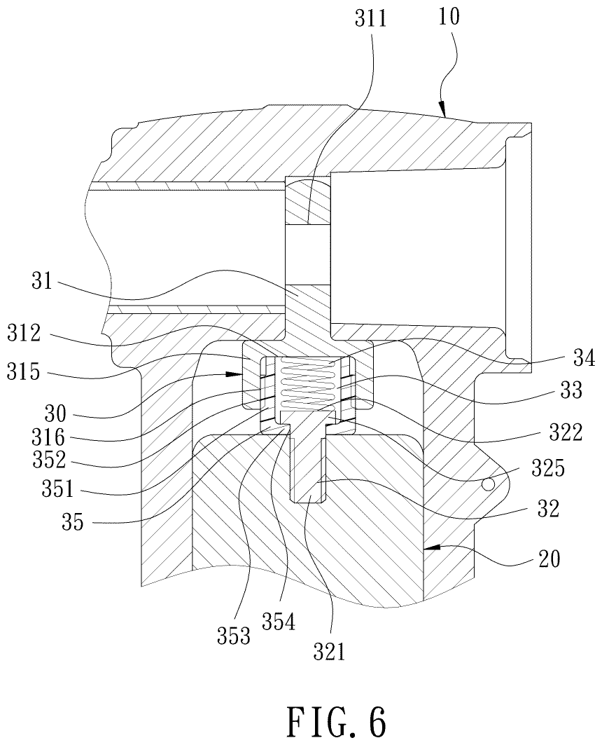

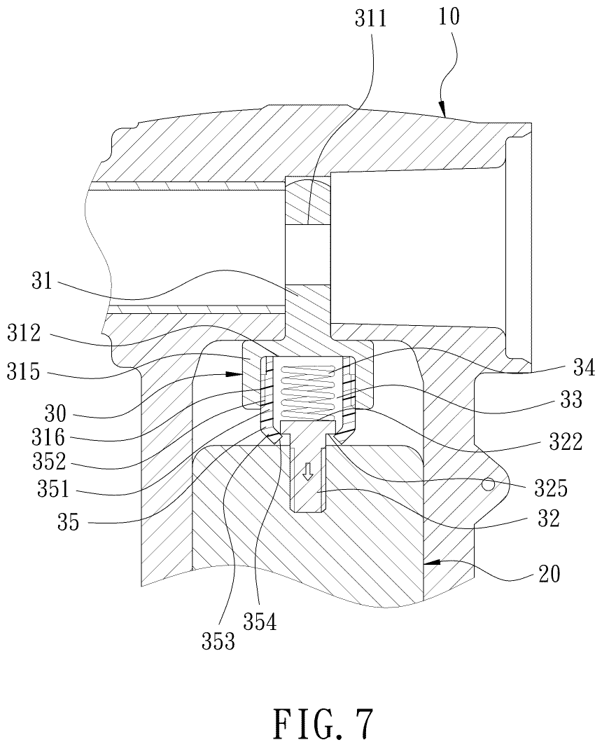

FIG. 5 is a cross-sectional view according to a second embodiment of the present invention. FIG. 6 is a partial, enlarged cross-sectional view according to the second embodiment of the present invention. FIG. 7 is a schematic view showing the operation of the second embodiment of the present invention. The coupling surge arrester 100 of the second embodiment is substantially similar to the first embodiment with the exceptions described below. The body 10 is in a T shape and has two coupling heads 11. The first conductor 31 is fixed to the body 10. One end of the first conductor 31 has the connecting portion 311. The connecting portion 311 is located between the coupling heads 11. The connecting portion 311 is a connecting hole. The other end of the first conductor 31 has the first contact surface 312 and a fixed annular wall 315 surrounding the first contact surface 312. The insulating member 35 has an annular body 351. The annular body 351 is made of an insulating material, such as plastic and rubber, and is fixed to the inner annular surface of the fixed annular wall 315. In this embodiment, the inner annular surface of the fixed annular wall 315 has an internal thread 316, and the outer annular surface of the annular body 351 has an external thread 352, so that the annular body 351 is threadedly connected to the inner annular surface of the fixed annular wall 315. One end of the annular body 351 has an annular flange 353 extending inward. A through hole 354 is defined in the center of the annular flange 353. The second conductor 32 is slidably inserted through the through hole 354. One end of the second conductor 32 extends out of the through hole 354 and has the second connecting portion 321. The second connecting portion 321 is connected to the arrester module 20. The other end of the second conductor 32 is inserted into the through hole 354 and enlarged outward to form a head portion 325. The head portion 325 has an end surface defined as the second contact surface 322. The closed chamber 33 is enclosed between the first contact surface 312 and the second contact surface 322. The conductive member 34 is disposed in the closed chamber 33. The second conductor 32 is slidable relative to the first conductor 31. The insulating member 35 is disposed between the first conductor 31 and the second conductor 32 so that the first conductor 31 and the second conductor 32 do not come into contact with each other. As shown in FIG. 7, When the continuously passing current causes the temperature of the conductive member 34 to rise sharply, the air inside the closed chamber 33 will expand rapidly after being heated, such that the second conductor 32 is pushed to slide relative to the first conductor 31 to cause a circuit break, so that the current no longer flows to the ground through the arrester module 20. This can prevent the arrester module 20 from exploding and cracking.

What is claimed is:

1. A coupling surge arrester, comprising a body, the body having at least one coupling head for connecting an external connector and an accommodating portion for accommodating an arrester module; characterized by:
the body further having a communicating portion between the coupling head and the accommodating portion, a trip unit being provided in the communicating portion, the trip unit including:
a first conductor, disposed close to the coupling head, one end of the first conductor having a first connecting portion, the first connecting portion being electrically connected to the external connector, another end of the first conductor having a first contact surface;
a second conductor, disposed close to the accommodating portion, the second conductor being slidable relative to the first conductor, one end of the second conductor having a second connecting portion, the second connecting portion being electrically connected to the arrester module, another end of the second conductor having a second contact surface, a closed chamber being enclosed between the first contact surface and the second contact surface;
at least one conductive member, disposed in the closed chamber, two ends of the conductive member being in contact with the first contact surface and the second contact surface respectively so that the first conductor and the second conductor are electrically connected through the conductive member;
at least one insulating member, disposed between the first conductor and the second conductor so that the first conductor and the second conductor do not come into contact with each other.

2. The coupling surge arrester as claimed in claim 1, wherein the first conductor has a first annular wall surrounding the first contact surface, the second conductor has a second annular wall surrounding the second contact surface, the second annular wall has an outer diameter less than an inner diameter of the first annular wall so that the second annular wall is slidably accommodated within an inner annular side of the first annular wall, and the insulating member is disposed between the first annular wall and the second annular wall.

3. The coupling surge arrester as claimed in claim 2, wherein the insulating member is a ring made of an insulating material.

4. The coupling surge arrester as claimed in claim 3, wherein an inner annular surface of the first annular wall has at least one first annular groove, an outer annular surface of the second annular wall has at least one corresponding second annular groove, and the insulating member is received in the first annular groove and the second annular groove.

5. The coupling surge arrester as claimed in claim 1, wherein the conductive member is a wire made of metal.

6. The coupling surge arrester as claimed in claim 5, wherein the conductive member is a metal spring, and the two ends of the conductive member are elastically pressed against the first contact surface and the second contact surface, respectively.

7. The coupling surge arrester as claimed in claim 1, wherein the first conductor has a fixed annular wall surrounding the first contact surface, the insulating member has an annular body made of an insulating material, the annular body is fixed to an inner annular surface of the fixed annular wall, one end of the annular body has an annular flange extending inward, a through hole is defined in a center of the annular flange, the second conductor is slidably inserted through the through hole, the end having the second connecting portion of the second conductor extends out of the through hole, the another end of the second conductor is inserted into the through hole and enlarged outward to form a head portion, and the head portion has an end surface defined as the second contact surface.

8. The coupling surge arrester as claimed in claim 7, wherein the inner annular surface of the fixed annular wall has an internal thread, and an outer annular surface of the annular body has an external thread, so that the annular body is threadedly connected to the inner annular surface of the fixed annular wall.

9. The coupling surge arrester as claimed in claim 1, wherein the arrester module is a metal oxide arrester.
